(19) United States
(12) Patent Application Publication
(10) Pub. No.: US 2017/0008344 A1
(43) Pub. Date: Jan. 12, 2017

(54) Tire Tread For A Farm Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Patrick VERVAET, Clermont-Ferrand Cedex 9 (FR); Daniel REY, Clermont-Ferrand Cedex 9 (FR); Gautier LALANCE, Clermont-Ferrand Cedex 9 (FR); Jean-Luc MANGERET, Clermont-Ferrand Cedex 9 (FR)

(21) Appl. No.: 15/106,807

(22) PCT Filed: Dec. 18, 2014
(86) PCT No.: PCT/EP2014/078366

§ 371 Date: Jun. 20, 2016

(30) Foreign Application Priority Data
Dec. 20, 2013 (FR) 1363134

(51) Int. Cl. B60C 11/00; B60C 11/11; B60C 11/03

(52) U.S. Cl. CPC B60C 11/005; B60C 11/0008; B60C 11/0302; B60C 11/0311; B60C 11/11; B60C 2200/08; B60C 2011/0025; B60C 2011/0313

(57) ABSTRACT

Tire for a vehicle for agricultural use comprises tread (2), comprising lugs (3) separated by grooves (4), each lug (3) extending radially outwards, over a radial height H, from a bottom surface (5) as far as a contact face (6). A first lug portion (31), made of a first elastomeric compound, extends radially inwards, from the contact face (6) as far as a first interface (7), over a radial distance D₁ between 0.5 H (the radial height) and H. A second lug portion (32), made of a second elastomeric compound, extends radially inwards, from the first interface (7) as far as the bottom surface (5), over a radial distance D₂. The second elastomeric compound extends radially into the lugs (3) and grooves (4), from the bottom surface (5), as far as a second interface (8), over a radial distance D₃ between 3 mm and 15 mm.

The present invention relates to a tire for a vehicle for agricultural use, such as an agricultural tractor or an agri-industrial vehicle.

It relates more particularly to the tread of such a tire, which tread is intended to come into contact with the ground via a tread surface.

In what follows, the circumferential, axial and radial directions refer respectively to a direction tangential to the tread surface of the tire and oriented in the direction of rotation of the tire, to a direction parallel to the axis of rotation of the tire, and to a direction perpendicular to the axis of rotation of the tire. “Radially inside, and, respectively, radially outside” mean “closer to and, respectively, further away from, the axis of rotation of the tire”. “Axially inside and, respectively, axially outside” mean “closer to, and, respectively, further away from, the equatorial plane of the tire”, the equatorial plane of the tire being the plane passing through the middle of the tread surface of the tire and perpendicular to the axis of rotation of the tire.

A tire for an agricultural tractor is intended to run over various types of ground such as the more or less compacted soil of the fields, unmade tracks providing access to the fields, and the tarmac surfaces of roads. Bearing in mind the diversity of use, in the fields and on the road, a tire for an agricultural tractor and, in particular, the tread thereof, needs to offer a performance compromise between traction in the field, resistance to chunking, resistance to wear on road, rolling resistance, and vibrational comfort on the road.

The tread of a tire for an agricultural tractor generally comprises a plurality of lugs. The lugs are elements that are raised with respect to a bottom surface which is a surface of revolution about the axis of rotation of the tire.

A lug generally has an elongate parallelepipedal overall shape made up of at least one rectilinear or curvilinear portion, and is separated from the adjacent lugs by grooves. A lug may be made up of a succession of rectilinear portions, as described in documents U.S. Pat. No. 3,603,370, U.S. Pat. No. 4,383,567, EP795427 or may have a curvilinear shape, as set out in documents U.S. Pat. No. 4,446,902, EP903249, EP1831034.

In the radial direction, a lug extends from the bottom surface as far as the tread surface, the radial distance between the bottom surface and the tread surface defining the lug height. The radially exterior face of the lug, belonging to the tread surface, which comes into contact with the ground as the lug enters the contact patch in which the tire is in contact with the ground, is referred to as the contact face of the lug.

In the axial direction, a lug extends inwards, towards the equatorial plane of the tire, from an axially outer end face as far as an axially inner end face.

In the circumferential direction, a lug extends, in a preferred direction of rotation of the tire, from a leading face as far as a trailing face. A preferred direction of rotation means the direction of rotation recommended by the manufacturer of the tire for optimum use of the tire. By way of example, in the case of a tread comprising two rows of lugs configured in a V or chevron formation, the tire has a preferred direction of rotation according to the point of the chevrons. The leading face is, by definition, the face of which the radially outer edge face or leading edge face is first to come into contact with the ground when the lug enters the contact patch in which the tire is in contact with the ground, as the tire rotates. The trailing face is, by definition, the face of which the radially outer edge or trailing edge is last to come into contact with the ground when the lug enters the contact patch in which the tire is contact with the ground, as the tire rotates. In the direction of rotation, the leading face is said to be forward of the trailing face.

A lug usually, but not necessarily, has a mean angle of inclination with respect to the circumferential direction of close to 45°. This is because this mean angle of inclination in particular allows a good compromise between traction in the field and vibrational comfort. Traction in the field is better if the lug is more axial, namely if its mean angle of inclination with respect to the circumferential direction is close to 90°, whereas vibrational comfort is better if the lug is more circumferential, that is to say if its mean angle of inclination with respect to the circumferential direction is close to 0°. It is a well known fact that traction in the field is more greatly determined by the angle of the lug in the shoulder region, and this has led certain tire designers to offer a very curved lug shape, leading to a lug that is substantially axial at the shoulder and substantially circumferential in the middle of the tread.

The tread of a tire for an agricultural tractor generally comprises two rows of lugs as previously described. This distribution of lugs which are inclined with respect to the circumferential direction gives the tread a V shape commonly referred to as a chevron pattern. The two rows of lugs exhibit symmetry about the equatorial plane of the tire, often with a circumferential offset between the two rows of lugs, resulting from one half of the tread being rotated about the axis of the tire with respect to the other half of the tread. Furthermore, the lugs may be continuous or discontinuous and may be circumferentially distributed with a spacing that is either constant or variable.

The tread of a tire for an agricultural tractor thus comprises two types of element: the lugs, which are the raised elements, and the grooves which are the portions of bottom surface separating the lugs. These two types of element are loaded very differently. The lugs are more particularly sensitive to wear during use on roads and to attack by stones when used off-road or in the field. The grooves between the lugs are attacked mainly by the stalks left behind after harvest, when used in the field, and are also sensitive to chemical attack from ozone in so far as these grooves are not subjected to wear.

The inventors have therefore set themselves the objective of designing a tread for a vehicle for agricultural use that performs better both from the stand point of resistance to wear in road use and from the stand point of resistance to attack by the stalks left behind (stubble) when used in the field.

This objective has been achieved according to the invention using a tire for a vehicle for agricultural use, comprising:
a tread, intended to come into contact with the ground, comprising lugs separated from one another by grooves,
each lug extending radially outwards, over a radial height H, from a bottom surface as far as a contact face,
the grooves consisting of the portions of the bottom surface separating the lugs,
in each lug, a first lug portion, made of a first elastomeric compound, extending radially inwards, from the contact face as far as a first interface, over a radial distance D₁ at least equal 0.5 times and at most equal to 1 times the radial height H of the lug,
in each lug, a second lug portion, made of a second elastomeric compound, extending radially inwards, from the first interface as far as the bottom surface, over a radial distance D₂,
the second elastomeric compound extending radially into the lugs and the grooves, from the bottom surface as far as a second interface, over a radial distance D₃,
and the radial distance D₃ between the bottom surface and the second interface is at least equal to 3 mm and at most equal to 15 mm.

The invention seeks to achieve a differentiation in the performance of the tread between the lugs which are intended in particular to resist wear during road use and the grooves between the lugs, or even the roots of the lugs, which are intended in particular to resist attack during use in the field, for example attack from stalks left behind after harvest, or stubble. Because the lugs are the tread element subjected to wear, they are made predominantly, over a first portion, from a first elastomeric compound that is resistant to wear, whereas the lug portions positioned at the roots of the lugs, near the bottom surface, and the grooves between the lugs, which are the portions of bottom surface between the lugs, namely the elements that are not subjected to wear, are made of a second elastomeric compound resistant to attack.

According to the invention, for a given lug, a first lug portion extends from the contact face, intended to come into contact with the ground during running, as far as a first interface corresponding to the radially inner limit of the first lug portion. The first interface is radially outside the bottom surface or is situated level with the bottom surface. A first interface radially outside the bottom surface corresponds to a radial distance between the contact face and the first interface that is less than the radial height H of the lug, namely to a first lug portion representing less than 100% of the lug. A first interface situated at the bottom surface corresponds to a radial distance between the contact face and the first interface equal to the radial height H of the lug, namely to a first lug portion representing 100% of the lug.

In instances in which the first lug portion represents less than 100% of the lug, a second lug portion, made of a second elastomeric compound, extends radially inwards, from the first interface, corresponding to the interface between the first and second elastomeric compounds, as far as the bottom surface. This second portion constitutes the root of the lug.

In addition, the second elastomeric compound that makes up the second lug portion extends radially into the bottom surface, both radially into the lugs and radially into the grooves, as far as a second interface. This portion of tire lying between the bottom surface and the second interface, corresponding to the radially inner limit of the second elastomeric compound, is usually referred to as the void rubber. Its role is to protect the crown reinforcement of the tire radially on the inside of the tread from mechanical and physicochemical attack. The radial distance between the bottom surface and the second interface defines the thickness of the void rubber which is an important feature in protecting the crown reinforcement of the tire.

Finally, the radial distance D₃ between the bottom surface and the second interface is at least equal to 3 mm and at most equal to 15 mm. In other words, the thickness of the void rubber is between a lower limit equal to 3 mm and an upper limit equal to 15 mm. The lower limit corresponds to a minimal thickness below which the void rubber will no longer correctly perform its function of protecting the crown reinforcement. The upper limit corresponds to a maximum thickness above which the level of heat in the crown becomes too great. This interval guarantees a compromise between the ability of the crown of the tire to withstand attack and the endurance thereof from a thermal standpoint.

Advantageously, with the first elastomeric compound having a complex dynamic shear modulus G₁* at 50% deformation and at 60° C., the complex dynamic shear modulus G₁* of the first elastomeric compound is at least equal to 1.2 MPa and preferably at most equal to 2 MPa. A complex dynamic shear modulus G₁* at 50% deformation and at 60° C. lying within such a range of values gives the first elastomeric compound cohesion properties which are favourable to withstanding attack of the road wear type and from stones.

Advantageously also, with the first elastomeric compound having a loss factor tan(δ₁) at 60° C., the loss factor tan(δ₁) of the first elastomeric compound is at least equal to 0.18 and at most equal to 0.32. A loss factor tan(δ₁) lying within such a range of values makes it possible to limit the dissipation of energy.

In general, the complex modulus G* and the loss factor tan(δ) of an elastomeric compound are properties referred to as dynamic. They are measured on a viscoanalyser of the Metravib VA4000 type, in accordance with standard ASTM D 5992-96. The response of a sample of the vulcanised elastomeric compound, in the form of a cylindrical test specimen 4 mm thick and 400 mm² in cross section, subjected to simple alternating sinusoidal shear loading at a frequency of 10 Hz, at a given temperature, for example of 60° C., is recorded. An outward cycle scans through amplitudes of deformation from 0.1% to 50%, then a return cycle sweeps from 50% to 1%. The results exploited are the complex dynamic shear modulus G* and the loss factor tan (δ). For the return cycle, the maximum observed value of tan(δ) is indicated, and this is denoted tan (δ)ₘₐₓ.

From the standpoint of the chemical composition, the first elastomeric compound that makes up the first lug portion contains diene elastomers, reinforcing fillers and a crosslinking system. The diene elastomers conventionally used are selected from the group consisting of polybutadienes (BR), natural rubber (NR), synthetic polyisoprenes (PI) and stirene-butadiene copolymers (SBR). For preference, the elastomers are used in the form of NR/BR or SBR/BR blends, or even NR/BR/SBR blends. For preference, the SBRs used have dynamic glass transition temperatures or Tg values below −50° C., measured on a viscoanalyser of Metravib VA4000 type, in accordance with standard ASTM D 5992-96. As far as the reinforcing filler is concerned, the first elastomeric compound comprises at least a carbon black, such as a carbon black from the 200 and 100 series (ASTM grades), this black having a BET specific surface area greater than 100m²/g and being used at a rate of between 50 and 75 phr.

The first elastomeric compound, comprising the elastomer or elastomer blends and the carbon blacks mentioned hereinabove, offers satisfactory properties in terms of resistance to attack of the road wear type and attack by stones.

Advantageously, with the second elastomeric compound having a complex dynamic shear modulus G₂* at 50% deformation and at 60° C., the complex dynamic shear modulus G₂* of the second elastomeric compound is at least equal to 1 MPa and preferably at most equal to 1.7 MPa. A complex dynamic shear modulus G₂* at 50% deformation 60° C. of the second elastomeric compound, comprised within a range of values, gives the second elastomeric compound levels of stiffness favourable to limiting mechanical stress and favourable to limiting attack from stalk debris (stubble).

Advantageously also, with the second elastomeric compound having a loss factor tan (δ₂) at 60° C., the loss factor tan(δ₂) of the second elastomeric compound is at least equal to 0.15 and at most equal to 0.28. A loss factor tan (δ₂) comprised within such a range of values makes it possible to limit the dissipation of energy in that portion of the tire that is comprised between the bottom surface and the second interface, referred to as the void rubber.

From a chemical composition standpoint, the second elastomeric composition, that makes up the void rubber, comprises diene elastomers, reinforcing fillers and a crosslinking system. The diene elastomers conventionally used are preferably selected from the group consisting of natural rubber (NR), synthetic polyisoprenes (PI) and stirene-butadiene copolymers (SBR). For preference, the elastomers are used in the form of NR/BR or SBR/BR blends. For preference, the SBRs used alone or in blends have dynamic glass transition temperatures or Tg values of between −65° C. and −40° C., measured on a viscoanalyser of Metravib VA4000 type in accordance with standard ASTM D 5992-96. As far as the reinforcing filler is concerned, the second elastomeric compound contains at least a carbon black, such as a carbon black black from the 300 series (ASTM grades) or even a carbon black from a higher series, this black black having a BET specific surface area of less than 100 m²/g and being used at a rate between 40 and 70 phr. The compositions of the second elastomeric compound of the void rubber of the tread may also contain all or some of the usual additives customarily employed in the elastomer compositions intended for the manufacture of tires, particularly sealing layers, such as protective agents for example such as anti-ozone waxes, chemical anti-ozone agents, antioxidants, anti-fatigue agents. For example, these compositions contain protective agents such as paraffin wax at a rate of between 2 and 5 phr, preferably from 2 to 3 phr, and N-1,3-dimethylbutyl-N-phenylparaphenylenediamine (6-PPD) at a rate of between 3 and 5 phr, preferably from 3 to 4 phr.

The second elastomeric compound, containing the elastomers or elastomer blends, the carbon blacks and the anti-oxidants and anti-ozone agents mentioned hereinabove, offers satisfactory properties in terms of resistance to attack from stalk debris or stubble and to chemical attack of the ozone type.

As far as industrial workability is concerned, a tire according to the invention and, more specifically, the tread of such a tire, can be manufactured according to a method as described and claimed in document WO 2009131578. The invention described and claimed in document WO 2009131578 relates to methods and to a device for forming a multilayer tire compound, the steps of the method involving:
using a mechanical system, the system comprising a plurality of cutting elements;
moving a sheet of material along a path through the mechanical system;
cutting a first strip from the sheet using one or more elements of the plurality of cutting elements, this step taking place during the movement step;
mechanically applying the first strip to a building surface, this step taking place during the movement step;
cutting a second strip from the sheet after the step of cutting the first strip, this step taking place during the movement step;
mechanically applying the second strip to a building surface, this step taking place during the movement step.

Specific embodiments of the method described hereinabove, relating to a multilayer manufacture of the tread, have also been described in documents WO 2013176675 and WO 2013176676.

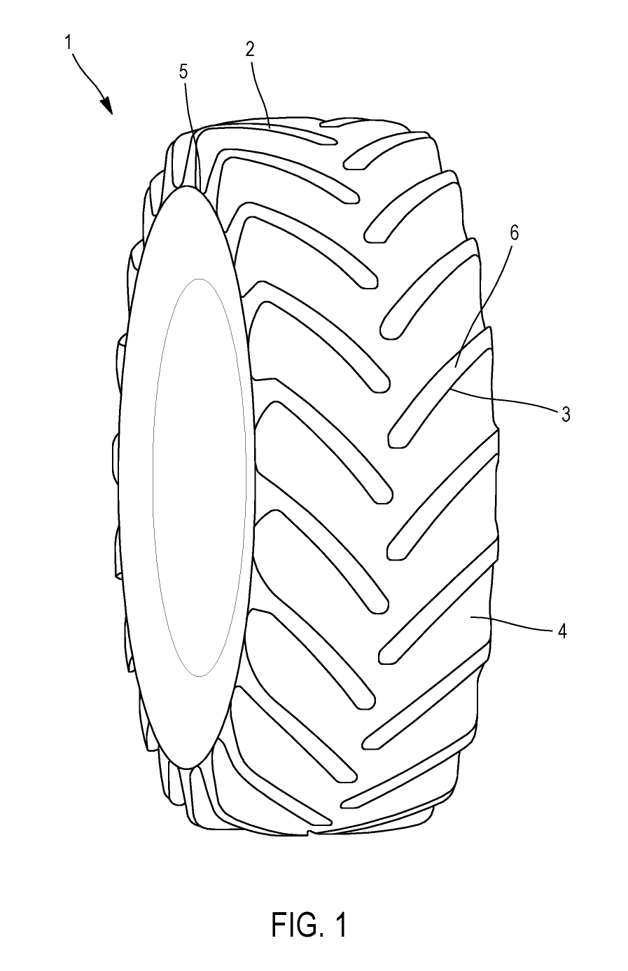

The present invention will be better understood with the aid of the appended FIGS. 1 to 3 which are schematic and not drawn to scale:

FIG. 1: a perspective view of a tire for a vehicle for agricultural use,

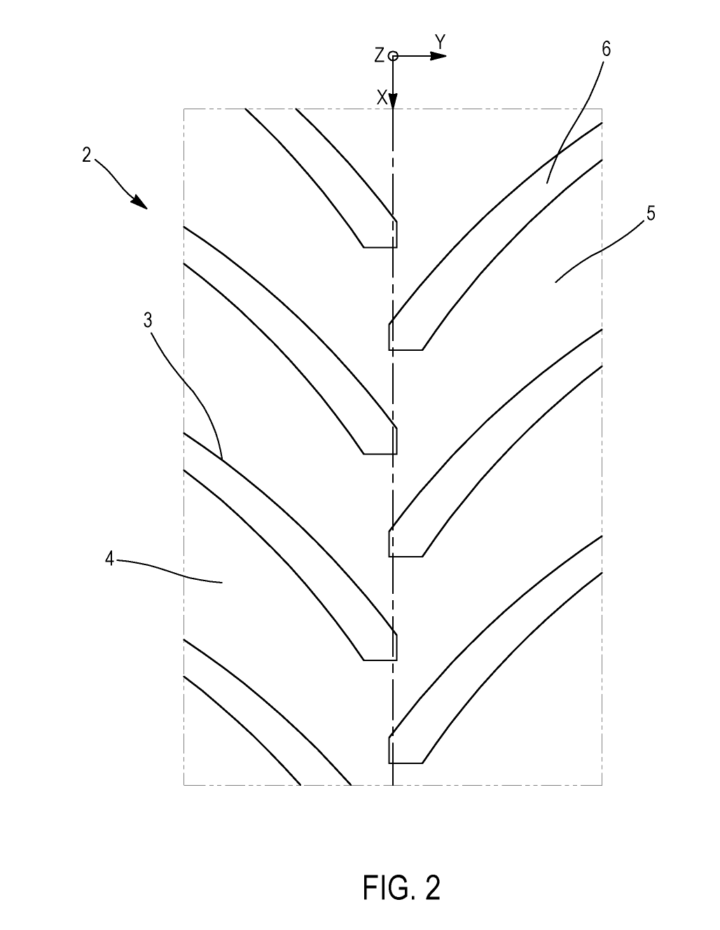

FIG. 2: a view in a radial direction (Z) of the tread of a tire for a vehicle for agricultural use,

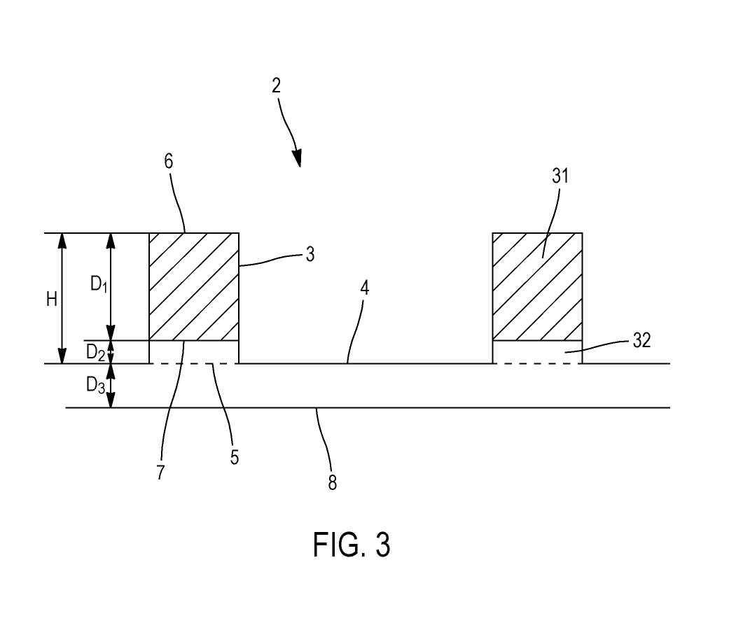

FIG. 3: a view in section on a meridian plane (XY) of a portion of tread of a tire according to the invention.

FIGS. 1 and 2 respectively depict a perspective view of a tire 1 for a vehicle for agricultural use, and a view, in a radial direction Z, of the tread of such a tire. The tread 2, intended to come into contact with the ground via a tread surface, comprises lugs 3 separated from one another by grooves 4. This lug 3 extends radially outwards, from the bottom surface 5 as far as a contact face 6 positioned in the tread surface. The grooves 4 consist of the portions of the bottom surface 5 that separate the lugs 3.

FIG. 3 shows a view in cross section, on a meridian plane (XY), of a portion of tread 2 of a tire according to the invention. In each lug 3, a first lug portion 31, made of a first elastomeric compound, extends radially inwards, from the contact face 6 as far as a first interface 7, over a radial distance D₁ at least equal 0.5 times and at most equal to 1 times the radial height H of the lug. Also in each lug 3, a second lug portion 32, made of a second elastomeric compound, extends radially inwards, from the first interface 7 as far as the bottom surface 5, over a radial distance D₂. In addition, the second elastomeric compound extends radially into the lugs 3 and the grooves 4 from the bottom surface 5 as far as a second interface 8 over a radial distance D₃. The portion of tire comprised between the bottom surface 5 and the second interface 8 constitutes the void rubber.

The invention has been studied in more particular detail for an agricultural tire in which the first elastomeric compound has a complex dynamic shear modulus G₁* equal to 1.72 MPa and a loss factor tan (δ₁) equal to 0.29, and the second elastomeric compound has a complex dynamic shear modulus G₂* equal to 1.31 MPa and a loss factor tan (δ₂) equal to 0.22.

The first and second elastomeric compounds may have chemical compositions that differ from those described hereinabove, depending on the desired performance sought.

The invention can be extended to a tread comprising lugs made of a first and of a second elastomeric compound, the second elastomeric compound being bounded by the bottom surface. The tire portion radially on the inside of the bottom surface may be made of at least a third elastomeric compound with a chemical composition different from those of the first and second elastomeric compounds.

The invention can be applied to any tire the tread of which comprises raised elements and which is likely to run over ground comprising aggressive indenting features, such as a construction plant tire.

1. A tire for a vehicle for agricultural use, comprising:
a tread, adapted to come into contact with the ground, comprising lugs separated from one another by grooves;
each lug extending radially outwards, over a radial height H, from a bottom surface as far as a contact face;
the grooves being defined at least partially by portions of the bottom surface separating the lugs;
wherein, in each said lug, a first lug portion, made of a first elastomeric compound, extends radially inwards, from the contact face as far as a first interface, over a radial distance D₁ at least equal 0.5 times and at most equal to 1 times the radial height H of the lug, wherein, in each said lug, a second lug portion, made of a second elastomeric compound, extends radially inwards, from the first interface as far as the bottom surface, over a radial distance D₂, wherein the second elastomeric compound extends radially into the lugs and the grooves, from the bottom surface as far as a second interface, over a radial distance D₃, and wherein the radial distance D₃ between the bottom surface and the second interface is at least equal to 3 mm and at most equal to 15 mm.

2. The tire according to claim 1, the first elastomeric compound having a complex dynamic shear modulus G₁* at 50% deformation and at 60° C., wherein the complex dynamic shear modulus G₁* of the first elastomeric compound is at least equal to 1.2 MPa.

3. The tire according to claim 1, the first elastomeric compound having a loss factor tan (δ₁) at 60° C., wherein the loss factor tan (δ₁) of the first elastomeric compound is at least equal to 0.18 and at most equal to 0.32.

4. The tire according to claim 1, the second elastomeric compound having a complex dynamic shear modulus G₂* at 50% deformation and at 60° C., in which wherein the complex dynamic shear modulus G₂* of the second elastomeric compound is at least equal to 1 MPa.

5. The tire according to claim 1, the second elastomeric compound having a loss factor tan (δ₂) at 60° C., wherein the loss factor tan (δ₂) of the second elastomeric compound is at least equal to 0.15 and at most equal to 0.28.

6. The tire according to claim 2, wherein the complex dynamic shear modulus G1* of the first elastomeric compound is at most equal to 2 MPa.

7. The tire according to claim 4, wherein the complex dynamic shear modulus G₂* of the second elastomeric compound is at most equal to 1.7 MPa.
